(19) United States
(12) Patent Application Publication
(10) Pub. No.: US 2019/0034546 A1
(43) Pub. Date: Jan. 31, 2019

(54) METHOD AND APPARATUS FOR USER-BASED PERSONALIZED DATA SEARCH

(71) Applicant: ALIBABA GROUP HOLDING LIMITED, George Town (KY)

(72) Inventor: Xiaofei LI, Hangzhou (CN)

(21) Appl. No.: 16/149,046

(22) Filed: Oct. 1, 2018

Related U.S. Application Data
(63) Continuation of application No. PCT/CN2017/077245, filed on Mar. 20, 2017.

(30) Foreign Application Priority Data
Apr. 1, 2016 (CN) 201610203900.5

(51) Int. Cl. G06F 17/30

(52) U.S. Cl. CPC G06F 17/30867; G06F 17/3053; G06F 17/30294

(57) ABSTRACT

Methods and apparatuses for a user-based personalized data search are provided. A method comprising: receiving a search keyword entered by a user; acquiring data associated with the search keyword from a semantic dictionary, the data associated with the search keyword and the user each having a corresponding user group, respectively; and providing feedback data to the user according to the user group of the data associated with the search keyword, the user group of the user, and the data associated with the search keyword.

### CROSS REFERENCE TO RELATED APPLICATION

The present application claims the benefits of priority to International Patent Application number PCT/CN2017/077245, filed Mar. 20, 2017, which claims the benefits of priority to Chinese Patent Application No. 201610203900.5, filed Apr. 1, 2016, both of which are incorporated herein by reference in their entireties.

### TECHNICAL FIELD

The embodiments of the present disclosure relate to data processing technologies, and in particular, to methods and apparatuses for a user-based personalized data search.

### BACKGROUND

With the advent of the big data era, enterprises have collected more and more data. At the same time, to find required data in massive data is often as time-consuming as looking for a needle in a haystack. At present, most enterprises store data tables based on English names and English abbreviations, while users may search for data by using Chinese full names or English full names according to their choice of language.

When a user conducts a search by using a search keyword on a big data platform, the fastest way to obtain a search result is conducting the search by full matching of data table name. When multiple users use the same search keyword, sorting results of the found data are the same. However, in actual service scenarios, the users usually do not know a specific name of a desired data table in the big data platform. Therefore, if the searches conducted in Chinese, the users can only describe their requirements in Chinese based on their own interpretations. However, English names or English abbreviations are usually taken as names of data tables in the big data platform. Thus, it is difficult to accurately find the desired data in massive data. On the other hand, when using the same search keyword, users requesting different services usually expect different search results. If the big data platform gives identical search results to all the users, it only wastes the data searching time of the users.

In conclusion, the disadvantages of existing methods for a data search on a big data platform are as follows:
(a) a user conducts a search in Chinese and then matches the Chinese keyword with Chinese name and Chinese description information of data tables stored on the big data platform. However, there are millions of data tables on the big data platform, and it is hard for data managers to maintain all the Chinese information of these data tables.
(b) Even if the user conducts a search in English, for example, uses seller as a keyword. Although the user does not use Chinese, the data may not be named seller on the big data platform but named slr for short. In this case, a desired result cannot be found.
(c) The user can rapidly search for desired data only by knowing the names of all the data tables, which is almost impossible in the big data era when data is massive.
(d) in the above noted example in (c), the user can rapidly search for desired data only by consulting an experienced person, such as data development liaison, which virtually increases the time cost of many parties.
(e) when searches are conducted by using the same search keyword (key), results provided to a user doing a security service and a user doing an after-sales service are the same. However, the users may have different requirements. Thus, the service capability of the big data platform is reduced, and the user experience is relatively poor.

### SUMMERY OF THE DISCLOSURE

Embodiments of the present disclosure provide methods and apparatuses for a user-based personalized data search, so as to at least partially solve the technical problems existing in conventional art.

According to some embodiments of the present disclosure, a method for a user-based personalized data search is provided, the method comprising: receiving a search keyword entered by a user; acquiring data associated with the search keyword from a semantic dictionary, the data associated with the search keyword and the user each having a corresponding user group, respectively; and providing feedback data to the user according to the user group of the data associated with the search keyword, the user group of the user, and the data associated with the search keyword.

According to some embodiments of the present disclosure, the semantic dictionary is generated by: acquiring source data documents of one or more user groups, the one or more user groups including the user group of the data associated with the search keyword and the user group of the user; extracting data associated with the one or more user groups from the source data documents; and organizing the data associated with the one or more user groups to form the semantic dictionary.

According to some embodiments of the present disclosure, providing the feedback data to the user, further comprising: determining weight values of the data associated with the search keyword according to the user group of the data associated with the search keyword and the user group of the user; conducting a search using the data associated with the search keyword to obtain one or more search results; and feeding back the one or more search results to the user according to the weight values.

According to some embodiments of the present disclosure, determining the weight values of the data associated with the search keyword, further comprising: determining whether the data associated with the search keyword corresponding to the user have corresponding recorded weight values; in response to determining that the data associated with the search keyword corresponding to the user have corresponding recorded weight values, using the recorded weight values as the weight values of the data associated with the search keyword; and in response to determining the data associated with the search keyword corresponding to the user do not have corresponding recorded weight values, determining the weight values of the data associated with the search keyword by using the user group of the user and the user group of the data associated with the search keyword.

According to some embodiments of the present disclosure, determining the weight values of the data associated with the search keyword, further comprising: determining whether the user group of the data associated with the search keyword is consistent with the user group of the user; in response to determining that the user group of the data associated with the search keyword is consistent with the user group of the user, allocating a first weight value to the data associated with the search keyword; and in response to determining that the user group of the data associated with the search keyword is inconsistent with the user group of the user, allocating a second weight value to the data associated with the search keyword, wherein the first weight value is greater than the second weight value.

According to some embodiments of the present disclosure, each of the one or more search results has a corresponding user group, and after feeding back the one or more search results to the user, the method further comprising: determining whether a user group of a search result, among the one or more search results, clicked by the user is consistent with the user group of the user; and in response to determining that the user group of the search result clicked by the user is inconsistent with the user group of the user, modifying the weight values of the data associated with the search keyword.

According to some embodiments of the present disclosure, modifying the weight values of the data associated with the search keyword, further comprising: modifying a first weight value of the data associated with the search keyword to a third weight value; and modifying a second weight value of the data associated with the search keyword to a fourth weight value, wherein the third weight value is equal to the fourth weight value.

According to some embodiments of the present disclosure, the data associated with the search keyword comprises Chinese words, English words, English abbreviations, Chinese abbreviations, similar words, near synonyms and synonyms.

According to some embodiments of the present disclosure, an apparatus for a user-based personalized data search is provided. The apparatus comprising: a search keyword receiving module configured to receive a search keyword entered by a user; an associated data acquisition module configured to acquire data associated with the search keyword from a semantic dictionary, the data associated with the search keyword and the user each having a corresponding user group, respectively; and a user data feedback module configured to provide feedback data to the user according to the user group of the data associated with the search keyword, the user group of the user and the data associated with the search keyword.

According to some embodiments of the present disclosure, the apparatus further comprising: a source data document acquisition module configured to acquire source data documents of one or more user groups, the one or more user groups including the user group of the data associated with the search keyword and the user group of the user; an associated data extraction module configured to extract data associated with the one or more user groups from the source data documents; and a semantic dictionary generation module configured to organize the data associated with the one or more user groups to form the semantic dictionary.

According to some embodiments of the present disclosure, the user data feedback module further comprising: a weight value determination sub-module configured to determine weight values of the data associated with the search keyword according to the user group of the data associated with the search keyword and the user group of the user; a result data searching sub-module configured to conduct a search using the data associated with the search keyword to obtain one or more search results; and a search result feedback sub-module configured to feed back the one or more search results to the user according to the weight values.

According to some embodiments of the present disclosure, the weight value determination sub-module, further comprising: a weight value judgment unit configured to determine whether the data associated with the search keyword corresponding to the user have corresponding recorded weight values, in response to determining that the data associated with the search keyword corresponding to the user have corresponding recorded weight values, the weight value judgment unit calls a first weight value assigning unit, and in response to determining the data associated with the search keyword corresponding to the user do not have corresponding recorded weight values, the weight value judgment unit calls a second weight value assigning unit, wherein the first weight value assigning unit is configured to use the recorded weight values as the weight values of the data associated with the search keyword, and wherein the second weight value assigning unit is configured to determine the weight values of the data associated with the search keyword by using the user group of the user and the user group of the data associated with the search keyword.

According to some embodiments of the present disclosure, the second weight value assigning unit, further comprising: a user group judgment sub-unit configured to determine whether the user group of the data associated with the search keyword is consistent with the user group of the user, in response to determining that the user group of the data associated with the search keyword is consistent with the user group of the user, the user group judgment sub-unit calls a first weight value allocation sub-unit, and in response to deteimining that the user group of the data associated with the search keyword is inconsistent with the user group of the user, the user group judgment sub-unit calls a second weight value allocation sub-unit; wherein the first weight value allocation sub-unit is configured to allocate a first weight value to the data associated with the search keyword, wherein the second weight value allocation sub-unit is configured to allocate a second weight value to the data associated with the search keyword, and wherein the first weight value is greater than the second weight value.

According to some embodiments of the present disclosure, each of the one or more search results has a corresponding user group, and the apparatus further comprising: a user group consistency judgment module configured to determine whether the user group of a search result clicked by the user is consistent with the user group of the user, in response to determining that the user group of the search result clicked by the user is inconsistent with the user group of the user, the user group consistency judgment module calls a weight value modifying module, wherein the weight value modifying module is configured to modify the weight values of the data associated with the search keyword.

According to some embodiments of the present disclosure, the weight value modifying module, further comprising: a third weight value assigning sub-module configured to modify a first weight value of the data associated with the search keyword to a third weight value, and modify a second weight value of the data associated with the search keyword to a fourth weight value, wherein the third weight value is equal to the fourth weight value.

According to some embodiments of the present disclosure, a method for a user-based personalized data search is provided. The method comprising: acquiring a search keyword entered by a user; sending the search keyword to a server, the server is configured to acquire data associated with the search keyword from a semantic dictionary, the data associated with the search keyword and the user each having a corresponding user group, respectively; receiving feedback data from the server, the server is configured to generate the feedback data according to the user group of the data associated with the search keyword, the user group of the user, and the data associated with the search keyword; and displaying the feedback data.

According to some embodiments of the present disclosure, an apparatus for a user-based personalized data search is provided. The apparatus comprising: a search keyword acquisition module configured to acquire a search keyword entered by a user; a search keyword sending module configured to send the search keyword to a server, the server is configured to acquire data associated with the search keyword from a semantic dictionary, the data associated with the search keyword and the user each having a corresponding user group, respectively; a feedback data receiving module configured to receive feedback data from the server, the server is configured to generate the feedback data according to the user group of the data associated with the search keyword, the user group of the user, and the data associated with the search keyword; and a feedback data display module configured to display the feedback data.

According to some embodiments of the present disclosure, a non-transitory computer readable medium that stores a set of instructions is provided. The non-transitory computer readable medium is executable by at least one processor of a computer system to cause the computer system to perform a method for a user-based personalized data search, the method comprising: receiving a search keyword entered by a user; acquiring data associated with the search keyword from a semantic dictionary, the data associated with the search keyword and the user each having a corresponding user group, respectively; and providing feedback data to the user according to the user group of the data associated with the search keyword, the user group of the user, and the data associated with the search keyword.

According to some embodiments of the present disclosure, a non-transitory computer readable medium that stores a set of instructions is provided. The non-transitory computer readable medium is executable by at least one processor of a computer system to cause the computer system to perform a method for a user-based personalized data search, the method comprising: acquiring a search keyword entered by a user; sending the search keyword to a server, the server is configured to acquire data associated with the search keyword from a semantic dictionary, the data associated with the search keyword and the user each having a corresponding user group, respectively; receiving feedback data from the server, the server is configured to generate the feedback data according to the user group of the data associated with the search keyword, the user group of the user, and the data associated with the search keyword; and displaying the feedback data.

### BRIEF DESCRIPTION OF THE DRAWINGS

FIG. 1 is a flowchart providing an exemplary method for a user-based personalized data search, consistent with some embodiments of the present disclosure;

FIG. 2 is a flowchart providing another exemplary method for a user-based personalized data search, consistent with some embodiments of the present disclosure;

FIG. 3 is a flowchart providing another exemplary method for a user-based personalized data search, consistent with some embodiments of the present disclosure;

FIG. 4 is a flowchart providing another exemplary method for a user-based personalized data search, consistent with some embodiments of the present disclosure;

FIG. 5 is a flowchart illustrating a personalized big data search based on a semantic dictionary, consistent with some embodiments of the present disclosure;

FIG. 6 is a schematic diagram illustrating an exemplary user search scenario, consistent with some embodiments of the present disclosure;

FIG. 7 is a schematic diagram illustrating another exemplary user search scenario, consistent with some embodiments of the present disclosure;

FIG. 8 is a schematic diagram illustrating another exemplary user search scenario, consistent with some embodiments of the present disclosure;

FIG. 9 is a schematic block diagram illustrating an exemplary apparatus for a user-based personalized data search, consistent with some embodiments of the present disclosure; and

FIG. 10 is a schematic block diagram illustrating another exemplary apparatus for a user-based personalized data search, consistent with some embodiments of the present disclosure.

### DETAILED DESCRIPTION

To make those skilled in the art better understand the present disclosure, the embodiments of the present disclosure are described below in further detail with reference to the accompanying drawings and specific implementation manners. Apparently, the described embodiments are merely some, rather than all, of the embodiments of the present disclosure. Based on the embodiments of the present disclosure, other embodiments obtained by those of ordinary skill in the art should belong to the protection scope of the present disclosure.

The embodiments of the present disclosure include, but are not limited to, the following advantages:

(a) a semantic dictionary is established for a big data scenario in consideration that system storage words used when data is stored on a big data platfoini, i.e., names used when the data is stored, are inconsistent with search keywords entered by users and that data required by users belonging to different user groups differs from each other.

(b) association between a search keyword entered by a user and the system storage words is established in the semantic dictionary. When the user enters the search keyword to conduct a search, data associated with the search keyword, that is, latent system storage words of the data that the user is searching for, is acquired from the semantic dictionary. The data associated with the search keyword and the user each belongs to one or more user groups, respectively, and data required by users belonging to different user groups usually differ from each other. Thus, feedback data will be provided to the user according to the data associated with the search keyword and the one or more user groups, so that data meeting the user's requirement can be provided to the user. By using a semantic dictionary, the embodiments of the present disclosure resolve the problem of difference between a search keyword entered by a user and words stored in a system, and narrow the gap between data itself and a value generated from the use of the data, thus making it possible to rapidly search for required data from massive data.

According to some embodiments of the present disclosure, when feedback data is provided to a user, weight values are first allocated according to the one or more user groups of the data associated with the search keyword and one or more user groups of the user; then, a search is conducted using the data associated with the search keyword to obtain one or more search results, the one or more search results are sorted according to weight values and then displayed to the user. As the one or more search results are fed back to the user sequentially according to the weight values, that is, according to the extent to which the user needs the search results, the data fed back is more in line with the user's need and improves the user's search experience when other influencing factors are excluded.

According to some embodiments of the present disclosure, a user's click information on a search result among the one or more search results is acquired, and then weight values of data associated with the search keyword are further adjusted. If the search result clicked by the user is inconsistent with the one or more user groups of the user, the weight values of the data associated with the search keyword will be modified to be consistent. Then, when a search is conducted using the data associated with the search keyword once again, search results corresponding to the data associated with the search keyword should be equally displayed to the user in the case where other influencing factors are excluded. On the contrary, if the search result clicked by the user is consistent with the one or more user groups of the user, the weight values of the data associated with the search keyword do not need to be modified. Then, when a search is conducted by using the data associated with the search keyword once again, search results corresponding to the data associated with the search keyword should be displayed to the user according to weight values in the case where other influencing factors are excluded.

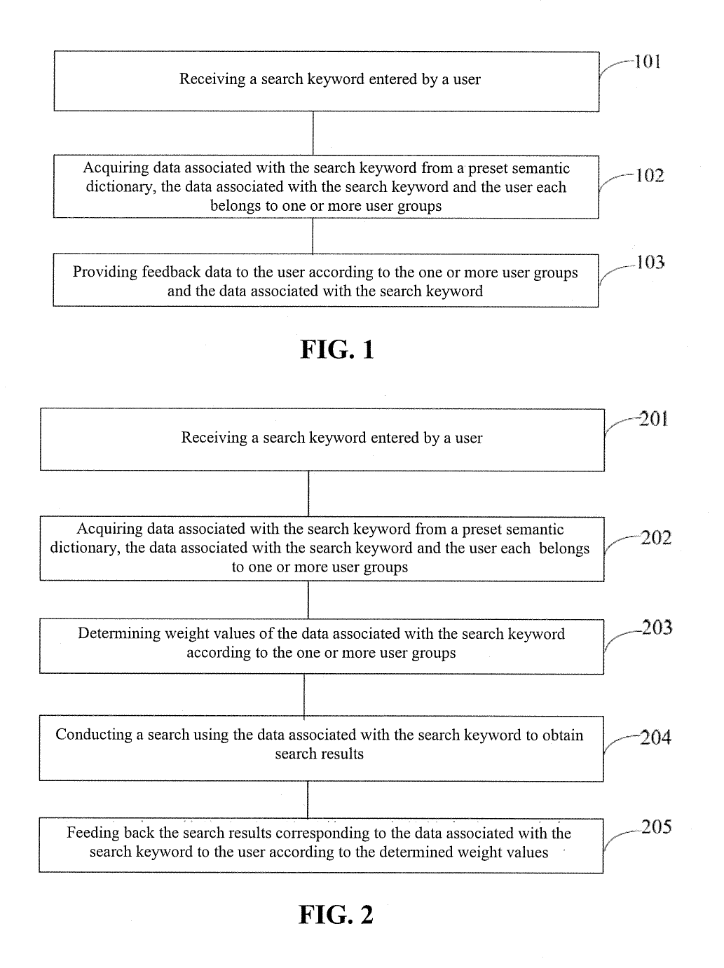

Referring to FIG. 1, a flowchart providing an exemplary method for a user-based personalized data search, consistent with some embodiments of the present disclosure. The method comprises the following steps:
Step 101. Receiving search keyword entered by a user.
Step 102. Acquiring data associated with the search keyword from a preset semantic dictionary, the data associated with the search keyword and the user each belongs to one or more user groups, respectively.
Step 103. Providing feedback data to the user according to the one or more user groups and the data associated with the search keyword.

In some embodiments of the present disclosure, the semantic dictionary may be generated by: acquiring source data documents of one or more user groups; extracting data associated with the one or more user groups from the source data documents; and organizing the data associated with the one or more user groups to form the semantic dictionary.

In some embodiments of the present disclosure, the user may belong to one user group or a plurality of user groups. By taking staffing in a company as an example, a user group to which a user belongs can be a department A or a department B. It is appreciated that data requested by multiple users belonging to different user groups may differ from each other. For example, a user belonging to department A may desire transaction-related information, and a user belonging to department B may desire commodity inventory information.

In some embodiments of the present disclosure, a semantic dictionary is established considering that system storage words used during data storage may be inconsistent with search keywords entered by users, and also, the data requested by multiple users belonging to different user groups may differ from each other.

Specifically, a semantic dictionary is established first by analyzing data modeling criterion documents, data design description documents, table use description documents and other related documents of different services and extracting texts from these documents. Data are generally stored in a manner of being named after English abbreviations in a big data scenario. Therefore, a semantic dictionary in some embodiments of the present disclosure specifically includes the following contents, in which a service domain refers to a user group to which a user belongs:
1. Service domain: searches conducted by users in different service domains will be matched with semantic dictionaries of different service domains.
2. English names: such as seller, computer, item, and product.
3. Chinese names: such as [symbol] (which is a Chinese word meaning seller), [symbol] (which is a Chinese word meaning computer), [symbol] (which is a Chinese word meaning item), and [symbol] (which is a Chinese word meaning product).
4. English abbreviations: such as slr, comp, itm, and prod.
5. Similar words, near synonyms, and synonyms.

A specific service scenario is described with the following examples. The semantic dictionary as shown in Table 1 may be obtained by collecting and analyzing data documents.

TABLE 1

| | Abbre- | English | | |
|---|---|---|---|---|
| Service domain | viation | name | Chinese name | Synonym |
| Department A | trd | trade | [symbol] (a Chinese word | Trade |
| | | | meaning trade) | |
| Department A | comp | computer | [symbol] (a Chinese word | Desktop, |
| | | | meaning computer) | notebook |
| Department A | itm | item | [symbol] (a Chinese word | Commodity |
| | | | meaning item) | |
| Department B | trd | trade | [symbol] (a Chinese word | Transaction |
| | | | meaning trade) | |
| Department B | prod | product | [symbol] (a Chinese word | Item, |
| | | | meaning product) | commodity |
| Department B | comp | compen- | [symbol] (a Chinese | |
| | | sation | word meaning | |
| | | | compensation) | |

At the same time, the semantic dictionary further corresponds to a user information table as shown in Table 2 below.

TABLE 2

| User name | Department to which the user belongs |
|---|---|
| U1 | Department A |
| | Department B |

In some embodiments of the present disclosure, when a user enters a search keyword to conduct a search, a search service will be provided for the user according to a semantic dictionary and a corresponding user information table. It should be noted that the embodiments of the present disclosure are not limited to a search within a company, they are also applicable to a larger data search scenario. In some embodiments of the present disclosure, user-related information can be also collected in advance, users are classified into user groups, then a semantic dictionary is established, and a search is conducted based on the semantic dictionary.

In some embodiments of the present disclosure, a semantic dictionary is established for a big data scenario in consideration that system storage words used when data are stored on a big data platform, i.e., the names used when the data are stored, are inconsistent with search keywords entered by users, and also, data requested by multiple users belonging to different user groups differ from each other. Association between search keywords entered by the users and the system storage words is established in the semantic dictionary. When a user enters a search keyword to conduct a search, data associated with the search keyword, that is, latent system storage words of the data requested by the user, is acquired from the semantic dictionary. The data associated with the search keyword and the user each belongs to one or more user groups, respectively. Feedback data will be provided to the user according to the data associated with the search keyword and the one or more user groups, so that data meeting the user's requirement can be provided for the user. By using a semantic dictionary, the embodiments of the present disclosure resolve the problem of difference between a search keyword entered by a user and words stored in a system, and narrows the gap between data itself and a value generated from the use of the data, thus making it possible to rapidly search for required data from massive data.

Referring to FIG. 2, a flowchart providing another exemplary method for a user-based personalized data search, consistent with some embodiments of the present disclosure. The method comprises the following steps:
Step 201. Receiving a search keyword entered by a user.
Step 202. Acquiring data associated with the search keyword from a preset semantic dictionary, the data associated with the search keyword and the user each belongs to one or more user groups, respectively.
Step 203. Determining weight values of the data associated with the search keyword according to the one or more user groups.
Step 204. Conducting a search using the data associated with the search keyword to obtain one or more search results.
Step 205. Feeding back the one or more search results corresponding to the data associated with the search keyword to the user according to the determined weight values.

In some embodiments of the present disclosure, after a user enters a search keyword, a pre-created semantic dictionary is called and data associated with the same search keyword entered by multiple users are searched for in the semantic dictionary. The data associated with the search keyword belong to one or more user groups.

With reference to the above semantic dictionary and user information table, for example, when the search keyword entered by the user is “ [symbol] ” (a Chinese word meaning trade), two pieces of data associated with the search keyword, i.e., “trade” under department A and “trade” under department B, will be obtained. User groups to which the data associated with the search keyword belong are department A and department B, respectively. At the same time, the user belongs to a user group, and the user information table is called. When a user ID of the user is U1, it can be found from the user information table that the user group to which U1 belongs is depai tinent A.

In some embodiments of the present disclosure, step 203 may further comprise the following sub-steps:
Sub-step S11. Judging whether weight values for the data associated with the search keyword for the user are recorded; if yes, sub-step S12 is performed, and if no, sub-step S13 is performed.
Sub-step S12. Using the recorded weight values as the weight values of the data associated with the search keyword.
Sub-step S13. Determining the weight values of the data associated with the search keyword by using the one or more user groups of the user and the one or more user groups of the data associated with the search keyword.

In an example of the present disclosure, if the user has conducted a search by using the data associated with the search keyword previously, weight values of the data associated with the search keyword have been stored in the system. At this point, it is unnecessary to allocate weight values to the data associated with the search keyword, and the stored weight values can be used directly.

If the user has never conducted a search by using the data associated with the search keyword previously, it is necessary to allocate weight values to the data associated with the search keyword. Then, the weight values are allocated according to the one or more user groups to which the user belongs and the one or more user groups to which the data associated with the search keyword belong.

In some embodiments of the present disclosure, sub-step S13 of determining the weight values of the data associated with the search keyword by using the one or more user groups of the user and the one or more user groups of the data associated with the search keyword may comprise the following sub-steps:
Sub-step a1. Judging whether the one or more user groups of the data associated with the search keyword are consistent with the one or more user groups of the user; if yes, sub-step a2 is performed, and if no, sub-step a3 is performed.
Sub-step a2. allocating first weight value to the data associated with the search keyword.
Sub-step a3. allocating a second weight value to the data associated with the search keyword, wherein the first weight value is greater than the second weight value.

It can be understood that if the one or more user groups of the data associated with the search keyword is consistent with the one or more user groups of the user, it indicates that the data associated with the search keyword is highly relevant to the user. Hence, a search result corresponding to the data associated with the search keyword is supposed to be closer to the user's requirement. Thus, a large weight value can be allocated to the data associated with the search keyword. On the contrary, if the one or more user groups of the data associated with the search keyword is inconsistent with the one or more user groups of the user, it indicates that the data associated with the search keyword is not highly relevant to the user. Hence, a search result corresponding to the data associated with the search keyword is supposed to be different from the user's requirement. Thus, a smaller weight value can be allocated to the data associated with the search keyword.

In an example of the present disclosure, one or more search results will be obtained when a search is conducted using the data associated with the search keyword. The one or more search results will be sequentially displayed to the user according to allocated weight values of the data associated with the search keyword in the case where other influencing factors are not taken into account.

In an actual search scenario, a user usually conducts a search by using a Chinese full name or an English full name according to his/her own language preference, rather than an English abbreviation usually used by data. Hence, in some embodiments of the present disclosure, by using a semantic dictionary, the user can quickly find the corresponding English abbreviation by using a natural language and can rapidly find a desired result without understanding a table naming convention of a underlying table. Thus, the user experience is excellent.

In some embodiments of the present disclosure, when the user is provided with feedback data, weight values are allocated first according to the one or more user groups of the data associated with the search keyword and the one or more user groups of the user; then, a search is conducted using the data associated with the search keyword to obtain one or more search results, the one or more search results are sorted according to weight values and then displayed to the user. As the one or more search results are fed back to the user sequentially according to the weight values, that is, according to the extent to which the user needs the search results, the data fed back is more in line with the user's need and improves the user's search experience when other influencing factors are excluded.

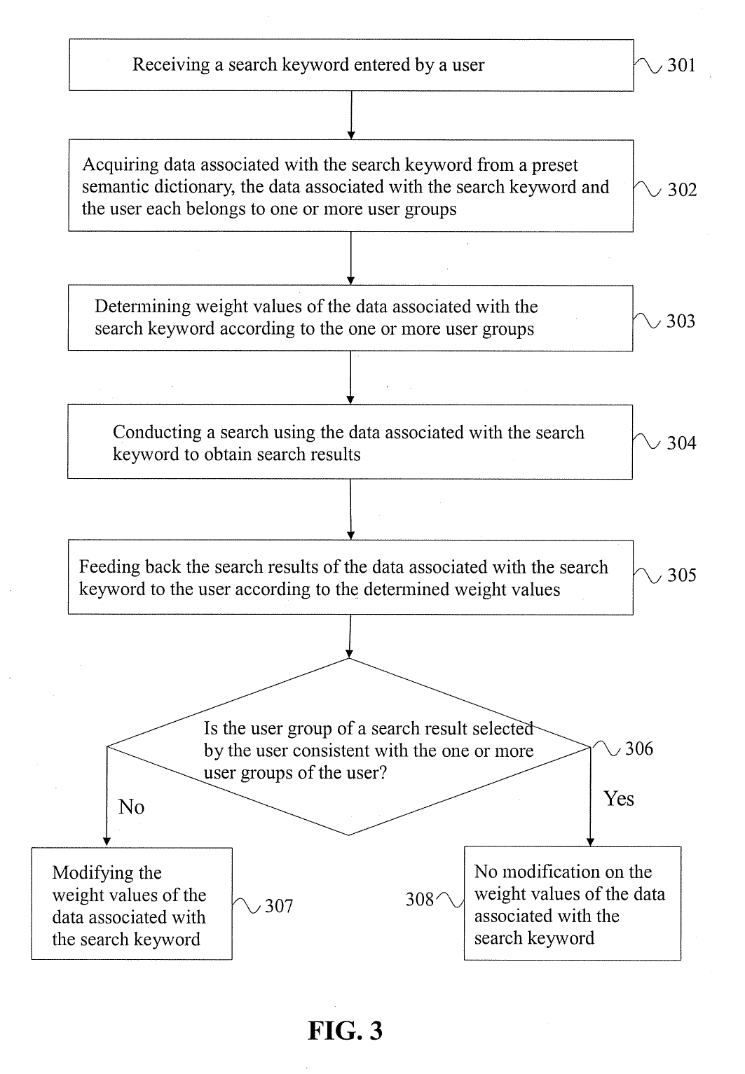

Referring to FIG. 3, a flowchart providing another exemplary method for a user-based personalized data search, consistent with some embodiments of the present disclosure. The method comprises the following steps:
Step 301. Receiving a search keyword entered by a user.
Step 302. Acquiring data associated with the search keyword from a preset semantic dictionary, the data associated with the search keyword and the user each belongs to one or more user groups, respectively.
Step 303. Determining weight values of the data associated with the search keyword according to the one or more user groups.
Step 304. Conducting a search using the data associated with the search keyword to obtain one or more search results.
Step 305. Feeding back the one or more search results corresponding to the data associated with the search keyword to the user according to the weight values.
Step 306. Judging whether a user group corresponding to a search result selected by the user is consistent with the one or more user groups of the user; if no, step 307 is performed; if yes, step 308 is performed.
Step 307: Modifying the weight values of the data associated with the search keyword.
Step 308: Continuing the search without modifying the weight values of the data associated with the search keyword.

In some embodiments of the present disclosure, step 307 may further include the following sub-step:
Sub-step S21. Modifying a first weight value of the data associated with the search keyword to a third weight value, and modifying a second weight value of the data associated with the search keyword to a fourth weight value, wherein the third weight value is equal to the fourth weight value.

In some embodiments of the present disclosure, after the one or more search results are fed back to the user, the user's click information on a search result, among the one or more search results, will be collected. If a user group of the search result clicked by the user is inconsistent with the one or more user groups of the user, the weight values of the data associated with the search keyword need to be changed. On the contrary, if the user group of the search result clicked by the user is consistent with the one or more user groups of the user, the weight values of the data associated with the search keyword do not need to be changed.

Specifically, if the user group of the search result clicked by the user is inconsistent with the one or more user groups of the user, the weight values of the data associated with the search keyword are modified to be consistent, so that priorities of the data associated with the search keyword are the same. For example, if weight values of the two pieces of the data associated with the search keyword are 0.9 and 0.1, respectively, the modified weight values of the data associated with the search keyword are 0.5 and 0.5. The above weight values are merely exemplary, and other values can also be adopted in practice, which is not limited in the embodiments of the present disclosure.

In an example of the present disclosure, the modified weight values of the data associated with the search keyword are stored, and the stored weight values can be used directly next time when the user uses the same data associated with the search keyword to conduct a search. Even if there is no modification, the weight values of the data associated with the search keyword can also be stored.

In some embodiments of the present disclosure, a user's click information on a search result, among the one or more search results, is acquired, and then weight values of the data associated with the search keyword are further adjusted. If the search result clicked by the user is inconsistent with the one or ore user groups of the user, the weight values of the data associated with the search keyword will be modified to be consistent. Then, when a search is conducted by using the data associated with the search keyword once again, search results corresponding to the data associated with the search keyword should be equally displayed to the user in the case where other influencing factors are excluded. On the contrary, if the search result clicked by the user is consistent with the one or more user groups of the user, the weight values of the data associated with the search keyword do not need to be modified. Then, when a search is conducted by using the data associated with the search keyword once again, search results corresponding to the data associated with the search keyword should be displayed to the user according to weight values in the case where other influencing factors are excluded.

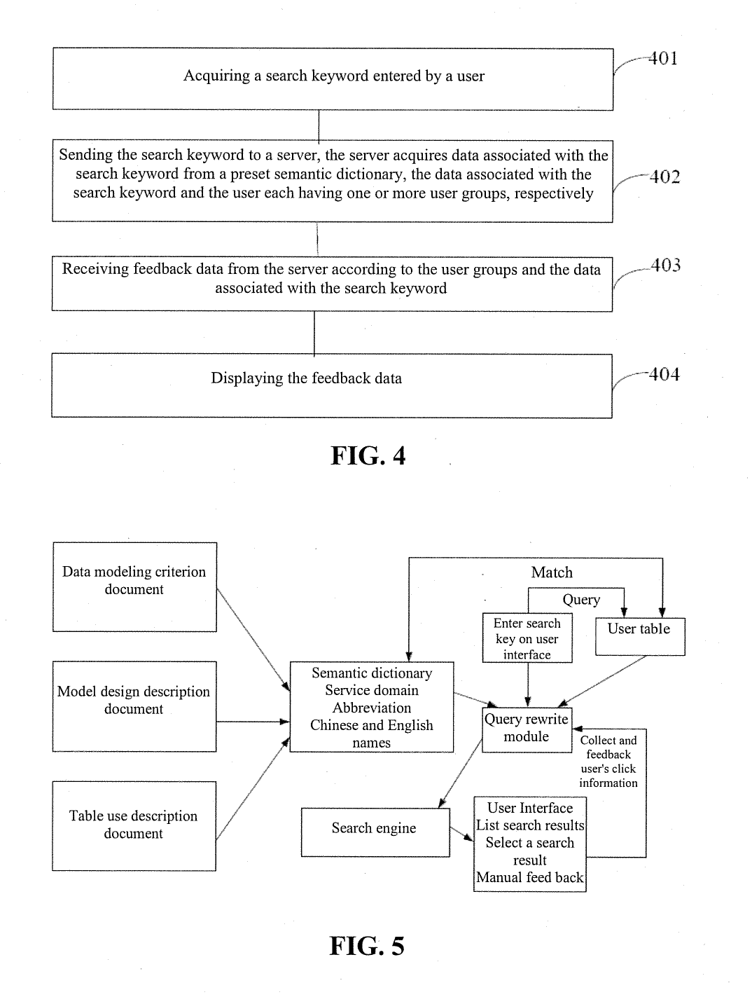

Referring to FIG. 4, a flowchart providing another exemplary method for user-based personalized data search, consistent with some embodiments of the present disclosure. The method comprises the following steps:
Step 401. Acquiring a search keyword entered by a user.
Step 402. Sending the search keyword to a server, the server is configured to acquire data associated with the search keyword from a preset semantic dictionary, the data associated with the search keyword and the user each belongs to one or more user groups, respectively.
Step 403. Receiving feedback data from the server according to the user groups and the data associated with the search keyword.
Step 404. Displaying the feedback data.

In some embodiments of the present disclosure, when a user enters a search keyword in a client terminal, the client terminal acquires the search keyword and then sends the search keyword to a server. The server searches a preset semantic dictionary for data associated with the search keyword, and then provides feedback data to the user based on the data associated with the search keyword, the one or more user groups of the data associated with the search keyword, and one or more user groups of the user. After receiving the feedback data from the server, the client terminal displays the feedback data to the user.

According to the embodiments of the present disclosure, even if a search keyword entered by a user is different from a name of data stored on a big data platform, the server can acquire data associated with the search keyword, that is, a name possibly used for the data that the user is searching for on the big data platform, from a preset semantic dictionary. As is well known, if a data is searched for directly using a name of the data, the data can be found quickly and accurately. Based on this characteristic, the user can find the required data quickly and accurately, and thus the user experience is excellent.

To enable those skilled in the art to better understand the embodiments of the present disclosure, the solution of a personalized big data search based on a semantic dictionary in the present disclosure is described in the following.

Referring to FIG. 5, a flowchart illustrating a personalized big data search based on a semantic dictionary, consistent with some embodiments of the present disclosure. A specific implementation process may be divided into the following parts:

1. Establishment of a Semantic Dictionary:

A semantic dictionary is established by collecting and analyzing data modeling criterion documents, data design description documents, table use description documents and other related documents in different service domains and extracting texts in these documents. The semantic dictionary includes user groups (hereinafter referred to as service domains) and Chinese names, English names, English abbreviations, Chinese abbreviations, similar words, near synonyms, and/or synonyms, and the like that are associated with each other.

2. User Search Scenario:

When a user searches for data on a user interface, a service domain to which the user belongs is determined by matching with a user information table, and data associated with a search keyword (a search key entered by the user) is determined by matching with a semantic dictionary. The data associated with the search keyword includes information such as English abbreviations, Chinese names, and English names associated with the search keyword. After the data associated with the search keyword is acquired, weight values are allocated to the data associated with the search keyword according to the service domain to which the user belongs and service domain to which the data associated with the search keyword belongs. The data associated with the search keyword is imported into a query rewrite module to rewrite a query condition. The user, the data associated with the search keyword, and the weight values are recorded in the query rewrite module at the same time and submitted to a search engine to conduct a search and query. One or more search results are finally fed back to the user. The one or more search results are sequentially displayed to the user on the user interface according to the weight values.

3. Rewriting of Weight Values.

The user's click information for a search result among the one or more search results is collected. The weight values of the data will be rewritten and fed back to the query rewrite module, for optimizing the weight values of the associated data corresponding to the user.

Further descriptions are given below by using several specific user search scenarios. Reference needs to be made to the semantic dictionary and the user information table in the foregoing text. Three search scenarios are shown as follows.

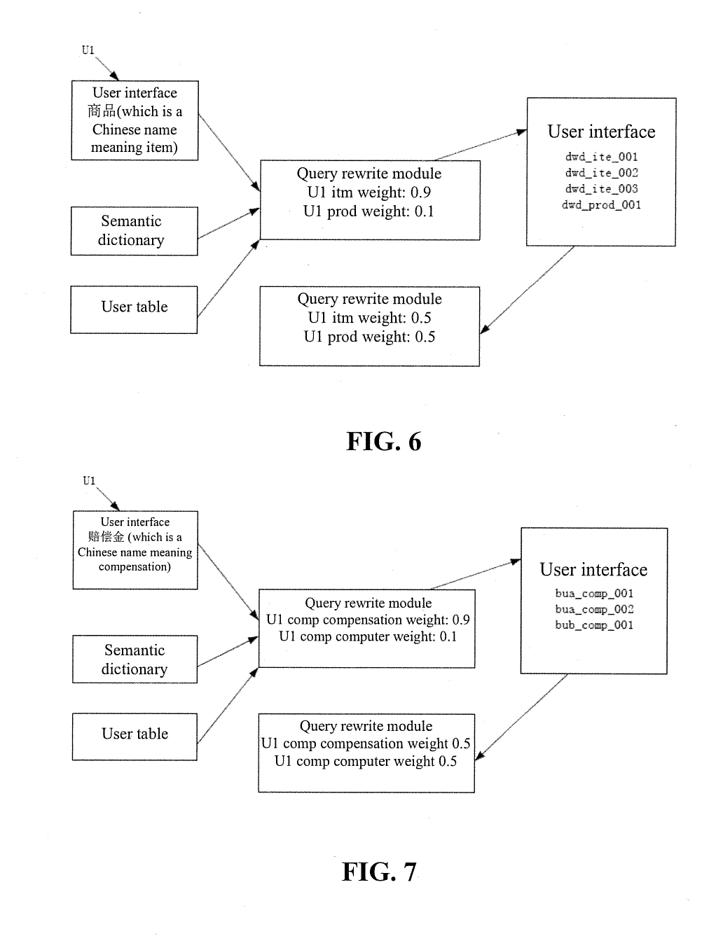

Scenario 1 is shown in FIG. 6, a schematic diagram illustrating an exemplary user search scenario, consistent with some embodiments of the present disclosure. As shown in FIG. 6, when a user U1 in a department A enters a search keyword “ [symbol] ” (a Chinese word meaning item) on a user interface, two pieces of data associated with the search keyword, i.e., “itm” under department A and “prod” under a department B will be obtained. As “itm” under department A and user U1 both belong to department A, a larger weight value 0.9 can be allocated to “itm” under department A, and a smaller weight value 0.1 can be allocated to “prod” under department B. When search results are obtained by using the above two pieces of data associated with the search keyword, the search results of the data associated with the search keyword are displayed on the user interface to the user sequentially in a descending order of the weight values. That is, a table including “itm” is ranked high, while a table including “prod” is ranked low. If the user clicks the table including “prod”, it is necessary to go back to the query rewrite module to modify the weight values of the data associated with the search keyword. Specifically, the weight value of “itm” under department A and the weight value of “prod” under department B can be modified to 0.5.

Scenario 2 is shown in FIG. 7, a schematic diagram illustrating another exemplary user search scenario, consistent with some embodiments of the present disclosure. As shown in FIG. 7, when the user U1 of a department A enters a search keyword “ [symbol] ” (a Chinese word meaning compensation) on the user interface, two pieces of data associated with the search keyword, i.e., “comp” under the department A and “comp” under a department B will be obtained. As the “comp” under department A and user U1 both belong to department A, a larger weight value 0.9 can be allocated to the “comp” under department A, and a smaller weight value 0.1 can be allocated to the “comp” under department B. When search results are obtained by using the above two pieces of data associated with the search keyword, the search results of the data associated with the search keyword are displayed on the user interface sequentially in a descending order of the weight values. That is, a table including the “comp” under department A is ranked high, while a table including the “comp” under department B is ranked low. If the user clicks the table including the “comp” under department B, it is necessary to go back to the query rewrite module to modify the weight values of the data associated with the search keyword. Specifically, the weight value of the “comp” under department A and the weight value of the “comp” under department B can be modified to 0.5.

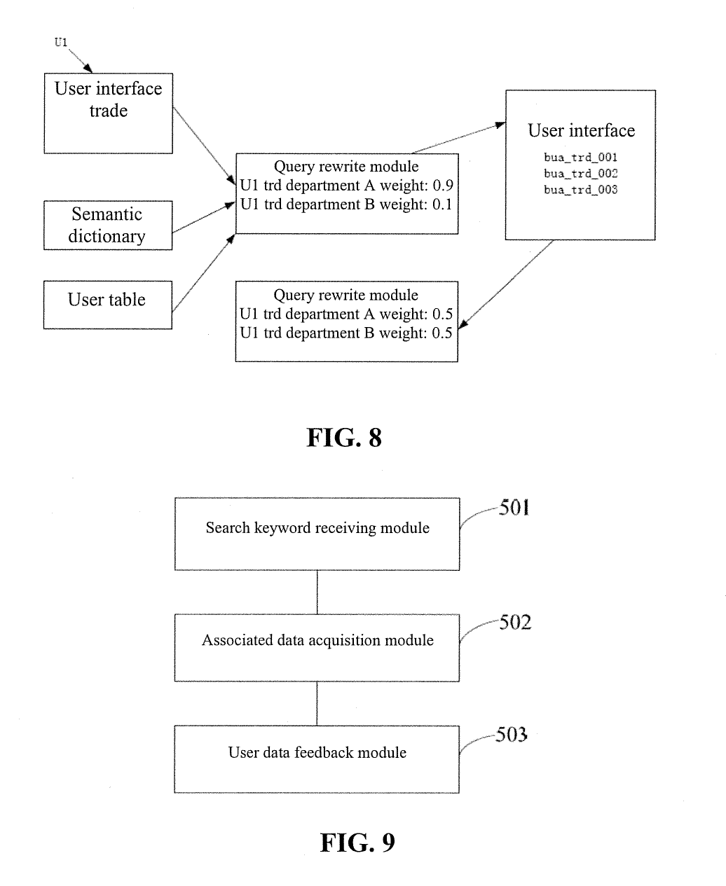

Scenario 3 is shown in FIG. 8, a schematic diagram illustrating another exemplary user search scenario, consistent with some embodiments of the present disclosure. As shown in FIG. 8, when a user U1 of a department A enters a search keywords “ [symbol] ” (a Chinese word meaning trade) on the user interface, two pieces of data associated with the search keyword, i.e., “trd” under the department A and “trd” under a department B will be obtained. As the “trd” under department A and user U1 both belong to department A, a larger weight value 0.9 can be allocated to the “trd” under department A, and a smaller weight value 0.1 can be allocated to the “comp” under department B. When search results are obtained by using the above two pieces of data associated with the search keyword, the search results of the data associated with the search keyword are displayed on the user interface to the user sequentially in descending order of the weight values. That is, a table including the “trd” under department A is ranked high, while a table including the “trd” under department B is ranked low. If the user clicks the table including the “trd” under department B, it is necessary to go back to the query rewrite module to modify the weight values of the data associated with the search keyword. Specifically, the weight value of the “trd” under department A and the weight value of the “trd” under department B can be modified to 0.5.

The foregoing several search scenarios are merely used as examples and can be further expanded as required in a specific application, which is not limited in the embodiments of the present disclosure.

The embodiments of the present disclosure are mainly directed to a big data scenario. Based on a situation where data in a big data platform usually uses English abbreviations as names when stored and in consideration of a scenario where an English abbreviation has different meanings as users have different concerns or belong to different fields, a semantic dictionary is extracted from a data modeling criterion or other data documents and is applied to intelligent matching when a user conducts a search by using a Chinese or English full name, thus making it possible to rapidly search for required data from massive data.

It should be noted that for ease of description, the foregoing method embodiments are all described as a series of action combinations. However, those skilled in the art should understand that the embodiments of the present disclosure are not limited to the described sequence of the actions, because some steps may be performed in another sequence or at the same time according to the embodiments of the present disclosure. In addition, those skilled in the art should also understand that the embodiments described in this specification all belong to preferred embodiments, and the involved actions are not necessarily mandatory to the embodiments of the present application.

Referring to FIG. 9, a schematic block diagram illustrating an exemplary apparatus for a user-based personalized data search, consistent with some embodiments of the present disclosure. The apparatus comprises: a search keyword receiving module 501 configured to receive a search keyword entered by a user; an associated data acquisition module 502 configured to acquire data associated with the search keyword from a preset semantic dictionary, the data associated with the search keyword and the user each having corresponding one or more user groups, respectively; and a user data feedback module 503 configured to provide feedback data to the user according to the one or more user groups and the data associated with the search keyword.

In some embodiments of the present disclosure, the user data feedback module 503 may comprise a weight value determination sub-module configured to determine weight values of the data associated with the search keyword according to the one or more user groups.

In some embodiments of the present disclosure, the weight value determination sub-module may further comprise: a weight value judgment unit configured to judge whether corresponding weight values have been recorded for the data associated with the search keyword for the user; if yes, call a first weight value assigning unit, and if no, call a second weight value assigning unit; the first weight value assigning unit is configured to use the recorded weight values as the weight values of the data associated with the search keyword; and the second weight value assigning unit is configured to determine the weight values of the data associated with the search keyword by using the one or more user groups of the user and the one or more user groups of the data associated with the search keyword.

In some embodiments of the present disclosure, the second weight value assigning unit may further comprise: a user group judgment sub-unit configured to judge whether the one or more user groups of the data associated with the search keyword are consistent with the one or more user groups of the user; if yes, call a first weight value allocation sub-unit, and if no, call a second weight value allocation sub-unit; the first weight value allocation sub-unit is configured to allocate a first weight value to the data associated with the search keyword; and the second weight value allocation sub-unit is configured to allocate a second weight value to the data associated with the search keyword; wherein the first weight value is greater than the second weight value.

In some embodiments of the present disclosure, the second weight value assigning unit may further comprise: a result data search module configured to conduct a search using the data associated with the search keyword to obtain one or more search results; and a search result feedback module configured to feed back the search results corresponding to the data associated with the search keyword to the user according to the weight values.

In some embodiments of the present disclosure, the apparatus may further comprise: a source data document acquisition module configured to acquire source data documents of one or more user groups; an associated data extraction module configured to extract data associated with the one or more user groups from the source data documents; and a semantic dictionary organizing module configured to organize the data associated with the one or more user groups to form the semantic dictionary.

In some embodiments of the present disclosure, the search results may have corresponding user groups, and the apparatus may further comprise: a user group consistency judgment module configured to judge whether a user group corresponding to a search result clicked by the user is consistent with the one or more user groups of the user; and if no, call a weight value modifying module; and the weight value modifying module is configured to modify the weight values of the data associated with the search keyword.

In some embodiments of the present disclosure, the weight value modifying module may comprise: a third weight value assigning sub-module configured to modify a first weight value of the data associated with the search keyword to a third weight value, and modify a second weight value of the data associated with the search keyword to a fourth weight value, wherein the third weight value is equal to the fourth weight value.

In some embodiments of the present disclosure, the data associated with the search keyword may comprise Chinese words, English words, English abbreviations, Chinese abbreviations, similar words, near synonyms, and/or synonyms.

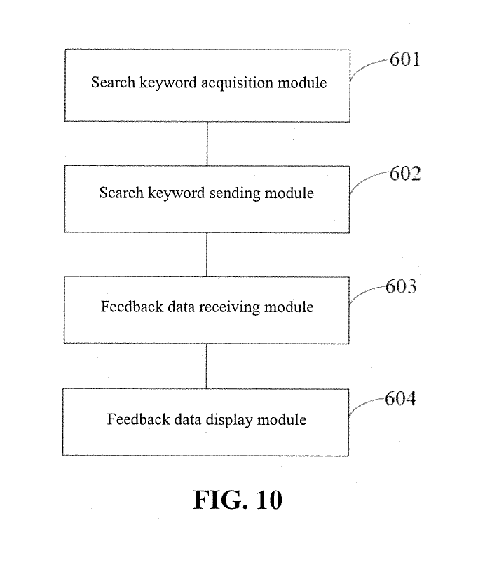

Referring to FIG. 10, a schematic block diagram illustrating another exemplary apparatus for a user-based personalized data search, consistent with some embodiments of the present disclosure. The apparatus comprises: a search keyword acquisition module 601 configured to acquire a search keyword entered by a user; a search keyword sending module 602 configured to send the search keyword to a server, the server is configured to acquire data associated with the search keyword from a preset semantic dictionary, the data associated with the search keyword and the user each having corresponding one or more user groups, respectively; a feedback data receiving module 603 configured to receive feedback data from the server according to the one or more user groups and the data associated with the search keyword; and a feedback data display module 604 configured to display the feedback data.

The apparatus embodiments include features similar to those described in the method embodiments, for simplicity, repeated descriptions are omitted here. For related parts, refer to the descriptions of the parts in the method embodiments. The embodiments in the specification are described progressively, each embodiment emphasizes a part different from other embodiments, and identical or similar parts of the embodiments may be obtained with reference to each other.

Those skilled in the art should understand that the embodiments according to the present disclosure may be provided as a method, an apparatus, or a computer program product. Therefore, the embodiments of the present disclosure may be implemented as a complete hardware embodiment, a complete software embodiment, or an embodiment combining software and hardware. Moreover, the embodiments of the present application may be in the form of a computer program product implemented on one or more computer usable storage media (including, but not limited to, a magnetic disk memory, a CD-ROM, an optical memory, and the like) including computer usable program codes.

In a typical configuration, the computer device includes one or more processors (CPU), an input/output interface, a network interface, and a memory. The memory may include a volatile memory, a random access memory (RAM) and/or a non-volatile memory or the like in a computer readable medium, for example, a read-only memory (ROM) or a flash RAM. The memory is an example of the computer readable medium. The computer readable medium includes non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store information accessible to the computing device. According to the definition in this text, the computer readable medium does not include transitory media, such as modulated data signals and carriers.

The embodiments of the present disclosure are described with reference to flowcharts and/or block diagrams according to the method, terminal device (system) and computer program product of the embodiments of the present disclosure. It should be understood that a computer program instruction may be used to implement each process and/or block in the flowcharts and/or block diagrams and combinations of processes and/or blocks in the flowcharts and/or block diagrams. The computer program instructions may be provided to a universal computer, a dedicated computer, an embedded processor or a processor of another programmable data processing terminal device to generate a machine, such that the computer or the processor of another programmable data processing terminal device executes an instruction to generate an apparatus configured to implement functions designated in one or more processes in a flowchart and/or one or more blocks in a block diagram.

The computer program instructions may also be stored in a computer readable memory that can guide the computer or another programmable data processing terminal device to work in a specific manner, such that the instruction stored in the computer readable storage generates an article of manufacture including an instruction apparatus, and the instruction apparatus implements functions designated by one or more processes in a flowchart and/or one or more blocks in a block diagram.

The computer program instructions may also be installed in a computer or another programmable data processing terminal device, such that a series of operation steps are executed on the computer or another programmable terminal device to generate a computer implemented processing. Therefore, the instruction executed in the computer or another programmable terminal device provides steps for implementing functions designated in one or more processes in a flowchart and/or one or more blocks in a block diagram.

Preferred embodiments of the present disclosure have been described; however, once knowing basic creative concepts, those skilled in the art can make other variations and modifications to the embodiments. Therefore, the appended claims are intended to be explained as including the preferred embodiments and all variations and modifications falling within the scope of the embodiments of the present disclosure.

Finally, it should be further noted that in this text, the relation terms such as first and second are merely used to distinguish one entity or operation from another entity or operation, and do not require or imply that the entities or operations have this actual relation or order. Moreover, the terms “include,” “comprise” or other variations thereof are intended to cover non-exclusive inclusion, so that a process, method, article or terminal device including a series of elements not only includes the elements, but also includes other elements not clearly listed, or further includes elements inherent to the process, method, article or terminal device. In the absence of more limitations, an element defined by “including a/an...” does not exclude that the process, method, article or terminal device including the element further has other identical elements.

A user-based personalized data search method and a user-based personalized data search apparatus provided in the present disclosure are described in detail above, and the principles and implementation manners of the present application are described by applying specific examples in this text. The above descriptions are merely used to help understand the method of the present disclosure and its core ideas. Meanwhile, for those of ordinary skill in the art, there may be modifications to the specific implementation manners and application scopes according to the idea of the present disclosure. Therefore, the content of the specification should not be construed as limitations to the present disclosure.

1. A method for a user-based personalized data search, the method comprising:
receiving a search keyword entered by a user;
acquiring data associated with the search keyword from a semantic dictionary, the data associated with the search keyword and the user each having a corresponding user group, respectively; and
providing feedback data to the user according to the user group of the data associated with the search keyword, the user group of the user, and the data associated with the search keyword.

2. The method according to claim 1, wherein the semantic dictionary is generated by:
acquiring source data documents of one or more user groups including the user group of the data associated with the search keyword and the user group of the user;
extracting data associated with the one or more user groups from the source data documents; and
organizing the data associated with the one or more user groups to form the semantic dictionary.

3. The method according to claim 1, wherein providing the feedback data to the user, further comprising:
determining weight values of the data associated with the search keyword according to the user group of the data associated with the search keyword and the user group of the user;
conducting a search using the data associated with the search keyword to obtain one or more search results; and
feeding back the one or more search results to the user according to the weight values.

4. The method according to claim 3, wherein determining the weight values of the data associated with the search keyword, further comprising:
determining whether the data associated with the search keyword corresponding to the user have corresponding recorded weight values;
in esponse to determining that the data associated with the search keyword corresponding to the user have corresponding recorded weight values, using the recorded weight values as the weight values of the data associated with the search keyword; and
in response to determining that the data associated with the search keyword corresponding to the user do not have corresponding recorded weight values, determining the weight values of the data associated with the search keyword by using the user group of the user and the user group of the data associated with the search keyword.

5. The method according to claim 4, wherein determining the weight values of the data associated with the search keyword, further comprising:
determining whether the user group of the data associated with the search keyword is consistent with the user group of the user;
in response to determining that the user group of the data associated with the search keyword is consistent with the user group of the user, allocating a first weight value to the data associated with the search keyword; and
in response to determining that the user group of the data associated with the search keyword is inconsistent with the user group of the user, allocating a second weight value to the data associated with the search keyword,
wherein the first weight value is greater than the second weight value.

6. The method according to claim 3, wherein each of the one or more search results has a corresponding user group, and after feeding back the one or more search results to the user, the method further comprising:
determining whether a user group of a search result, among the one or more search results, clicked by the user is consistent with the user group of the user; and
in response to determining that the user group of the search result clicked by the user is inconsistent with the user group of the user, modifying the weight values of the data associated with the search keyword.

7. The method according to claim 6, wherein modifying the weight values of the data associated with the search keyword, further comprising:
modifying a first weight value of the data associated with the search keyword to a third weight value; and
modifying a second weight value of the data associated with the search keyword to a fourth weight value,
wherein the third weight value is equal to the fourth weight value.

8. The method according to claim 1, wherein the data associated with the search keyword comprises Chinese words, English words, English abbreviations, Chinese abbreviations, similar words, near synonyms and synonyms.

9. An apparatus for a user-based personalized data search, the apparatus comprising:
a memory storing a set of instructions; and
a processor configured to execute the set of instructions to cause the apparatus to perform:
receiving a search keyword entered by a user;
acquiring data associated with the search keyword from a semantic dictionary, the data associated with the search keyword and the user each having a corresponding user group, respectively; and
providing feedback data to the user according to the user group of the data associated with the search keyword, the user group of the user and the data associated with the search keyword.

10. The apparatus according to claim 9, wherein the processor further executes the set of instructions to cause the apparatus to perform:
acquiring source data documents of one or more user groups, the one or more user groups including the user group of the data associated with the search keyword and the user group of the user;
extracting data associated with the one or more user groups from the source data documents; and
organizing the data associated with the one or more user groups to form the semantic dictionary.

11. The apparatus according to claim 9, wherein the processor further executes the set of instructions to cause the apparatus to perform:
determining weight values of the data associated with the search keyword according to the user group of the data associated with the search keyword and the user group of the user;
conducting a search using the data associated with the search keyword to obtain one or more search results; and
feeding back the one or more search results to the user according to the weight values.

12. The apparatus according to claim 11, wherein the processor further executes the set of instructions to cause the apparatus to perform:
determining whether the data associated with the search keyword corresponding to the user have corresponding recorded weight values,
in response to determining that the data associated with the search keyword corresponding to the user have corresponding recorded weight values, calling a first weight value assigning unit, and
in response to determining the data associated with the search keyword corresponding to the user do not have corresponding recorded weight values, calling a second weight value assigning unit,
wherein the first weight value assigning unit is configured to use the recorded weight values as the weight values of the data associated with the search keyword, and
wherein the second weight value assigning unit is configured to determine the weight values of the data associated with the search keyword by using the user group of the user and the user group of the data associated with the search keyword.

13. The apparatus according to claim 12, wherein the second weight value assigning unit comprises:
a user group judgment sub-unit configured to determine whether the user group of the data associated with the search keyword is consistent with the user group of the user,
in response to determining that the user group of the data associated with the search keyword is consistent with the user group of the user, the user group judgment sub-unit calls a first weight value allocation sub-unit, and
in response to determining that the user group of the data associated with the search keyword is inconsistent with the user group of the user, the user group judgment sub-unit calls a second weight value allocation sub-unit;
wherein the first weight value allocation sub-unit is configured to allocate a first weight value to the data associated with the search keyword,
wherein the second weight value allocation sub-unit is configured to allocate a second weight value to the data associated with the search keyword, and
wherein the first weight value is greater than the second weight value.

14. The apparatus according to claim 11, wherein each of the one or more search results has a corresponding user group, and the processor further executes the set of instructions to cause the apparatus to perform:
determining whether the user group of a search result clicked by the user is consistent with the user group of the user; and
in response to determining that the user group of the search result clicked by the user is inconsistent with the user group of the user, modifying the weight values of the data associated with the search keyword.

15. The apparatus according to claim 14, wherein the processor further executes the set of instructions to cause the apparatus to perform:
modifying a first weight value of the data associated with the search keyword to a third weight value; and
modifying a second weight value of the data associated with the search keyword to a fourth weight value, wherein the third weight value is equal to the fourth weight value.

16-17. (canceled)

18. A non-transitory computer readable medium that stores a set of instructions that is executable by at least one processor of a computer system to cause the computer system to perform a method for a user-based personalized data search, the method comprising:
receiving a search keyword entered by a user;
acquiring data associated with the search keyword from a semantic dictionary, the data associated with the search keyword and the user each having a corresponding user group, respectively; and
providing feedback data to the user according to the user group of the data associated with the search keyword, the user group of the user, and the data associated with the search keyword.

19. (canceled)

20. The method according to claim 1, wherein the user group of the with the search keyword or the user group of the user comprises a plurality of user groups.

21. The non-transitory computer readable medium according to claim 18, wherein the semantic dictionary is generated by:
acquiring source data documents of one or more user groups including the user group of the data associated with the search keyword and the user group of the user;
extracting data associated with the one or more user groups from the source data documents; and
organizing the data associated with the one or more user groups to form the semantic dictionary.

22. The non-transitory computer readable medium according to claim 18, wherein providing the feedback data to the user, further comprising:
determining weight values of the data associated with the search keyword according to the user group of the data associated with the search keyword and the user group of the user;
conducting a search using the data associated with the search keyword to obtain one or more search results; and
feeding back the one or more search results to the user according to the weight values.

23. The non-transitory computer readable medium according to claim 18, wherein determining the weight values of the data associated with the search keyword, further comprising:
determining whether the data associated with the search keyword corresponding to the user have corresponding recorded weight values;
in response to determining that the data associated with the search keyword corresponding to the user have corresponding recorded weight values, using the recorded weight values as the weight values of the data associated with the search keyword; and
in response to determining that the data associated with the search keyword corresponding to the user do not have corresponding recorded weight values, determining the weight values of the data associated with the search keyword by using the user group of the user and the user group of the data associated with the search keyword.
